(19) United States
(12) Patent Application Publication
(10) Pub. No.: US 2019/0365196 A1
(43) Pub. Date: Dec. 5, 2019

(54) DISHWASHER APPLIANCE AND VIEWABLE CLEANING AGENT ASSEMBLY

(71) Applicant: Haier US Appliance Solutions, Inc., Wilmington, DE (US)

(72) Inventors: Kyle Edward Durham, Louisville, KY (US); Craig Curtis, Crestwood, KY (US); Christopher Brandon Ross, Louisville, KY (US)

(21) Appl. No.: 15/996,573

(22) Filed: Jun. 4, 2018

(51) Int. Cl. A47L 15/44; F21V 8/00

(52) U.S. Cl. CPC A47L 15/4418; G02B 6/0058; G02B 6/0078

(57) ABSTRACT

A dishwasher appliance and viewable cleaning agent assembly are disclosed herein. The dispensing assembly may include an internal wall, a front cover, a light guide, and a light source. The internal wall may define a storage volume for the receipt of a wash fluid therein. The front cover may selectively cover the storage volume to restrict access thereto. The front cover may be positioned between the storage volume and the wash chamber when the door is in the closed position. The light guide may extend along an axial direction from a forward display surface in front of the storage volume to a rearward contact surface within the storage volume. The light source may be directed through the internal wall toward the rearward contact surface within the storage volume.

### FIELD OF THE INVENTION

The present subject matter relates generally to dishwasher appliances, and more particularly to dishwasher appliances and assemblies for receiving and viewing liquid cleaning agent to be utilized in cleaning or wash operations.

### BACKGROUND OF THE INVENTION

Dishwasher appliances generally include a tub that defines a wash compartment. Rack assemblies can be mounted within the wash compartment of the tub for receipt of articles for washing. In a typically known dishwasher appliance, spray assemblies within the wash compartment can apply or direct wash fluid towards articles disposed within the rack assemblies in order to clean such articles. Multiple spray assemblies can be provided including, for example, a lower spray arm assembly mounted to the tub at a bottom of the wash compartment, a mid-level spray arm assembly mounted to one of the rack assemblies, or an upper spray assembly mounted to the tub at a top of the wash compartment.

In order to facilitate cleaning of articles in a dishwasher appliance, cleaning agents or wash fluids are utilized. The cleaning agents generally mix with water in the wash compartment to form a fluid which is utilized to clean the articles during dishwasher appliance operation. Cleaning agents include, for example, detergents and rinse agents. In some cases, liquid cleaning agents are utilized.

For some existing appliances, cleaning agents are stored in reservoirs defined in the doors of dishwasher appliances and are dispensed from these reservoirs during operation of the dishwasher appliance. However, it can be difficult for a user to determine the amount of cleaning agent present within a reservoir. The user may be unaware of how much cleaning agent should be provided, or may be unable to see one or more visual indicators signifying the level of cleaning agent within the reservoir. If the cleaning agent is clear or translucent, visually estimating the amount of cleaning agent within the reservoir may be especially difficult.

As a result, it may be useful to provide a dishwasher appliance or assembly that may receive liquid cleaning agent and provide an easily viewed indication thereof. In particular, it would be advantageous if the amount or volume of cleaning agent within a storage volume or reservoir was highly visible to a user of the appliance, even after the storage volume was closed or otherwise sealed.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a dishwasher appliance is provided. The dishwasher appliance may include a tub, a door, a cleaning agent dispensing assembly. The tub may define a wash chamber for receipt of articles for washing. The tub may include a plurality of sidewalls. The door may be movable between a closed position and an open position. The door may include an inner wall further defining the wash chamber when the door is in the closed position. The cleaning agent dispensing assembly may be mounted to the door. The cleaning agent dispensing assembly may include an internal wall, a front cover, a light guide, and a light source. The internal wall may define a storage volume for the receipt of a wash fluid therein. The front cover may selectively cover the storage volume to restrict access thereto. The front cover may be positioned between the storage volume and the wash chamber when the door is in the closed position. The light guide may extend along an axial direction from a forward display surface in front of the storage volume to a rearward contact surface within the storage volume. The light source may be directed through the internal wall toward the rearward contact surface within the storage volume.

In another aspect of the present disclosure, a cleaning agent dispensing assembly for a dishwashing appliance is provided. The cleaning agent dispensing assembly may include an internal wall, a front cover, a light guide, and a light source. The internal wall may define a storage volume for the receipt of a wash fluid therein. The front cover may selectively cover the storage volume to restrict access thereto. The front cover may be positioned between the storage volume and the wash chamber when the door is in the closed position. The light guide may extend along an axial direction from a forward display surface in front of the storage volume to a rearward contact surface within the storage volume. The light source may be directed through the internal wall toward the rearward contact surface within the storage volume.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a dishwasher appliance according to exemplary embodiments of the present disclosure.

FIG. 2 provides a side, cross-sectional view of the exemplary dishwasher appliance of FIG. 1.

FIG. 3 provides a perspective view of a door for a dishwasher appliance according to exemplary embodiments of the present disclosure.

FIG. 4 provides a perspective view of a dispensing assembly for a dishwasher appliance according to exemplary embodiments of the present disclosure.

FIG. 5 provides a side, cross-sectional view of the exemplary dispensing assembly of FIG. 4.

FIG. 6 provides a top plan view of the exemplary dispensing assembly of FIG. 4.

FIG. 7 provides a perspective view of a portion of the exemplary dispensing assembly of FIG. 4.

FIG. 8 provides a perspective view of a light guide of the exemplary dispensing assembly of FIG. 4.

FIG. 9 provides a perspective view of a light guide for a dispensing assembly according to other exemplary embodiments of the present disclosure.

FIG. 10 provides a side schematic view of a dispensing assembly according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

It is noted that, for the purposes of the present disclosure, the terms “includes” and “including” are intended to be inclusive in a manner similar to the term “comprising.” Similarly, the term “or” is generally intended to be inclusive (i.e., “A or B” is intended to mean “A or B or both”).

As used herein, the term “article” may refer to, but need not be limited to, dishes, pots, pans, silverware, and other cooking utensils and items that can be cleaned in a dishwashing appliance. The term “wash cycle” is intended to refer to one or more periods of time during the cleaning process where a dishwashing appliance operates while containing articles to be washed and uses water or detergent to, for example, remove soil particles including food and other undesirable elements from the articles.

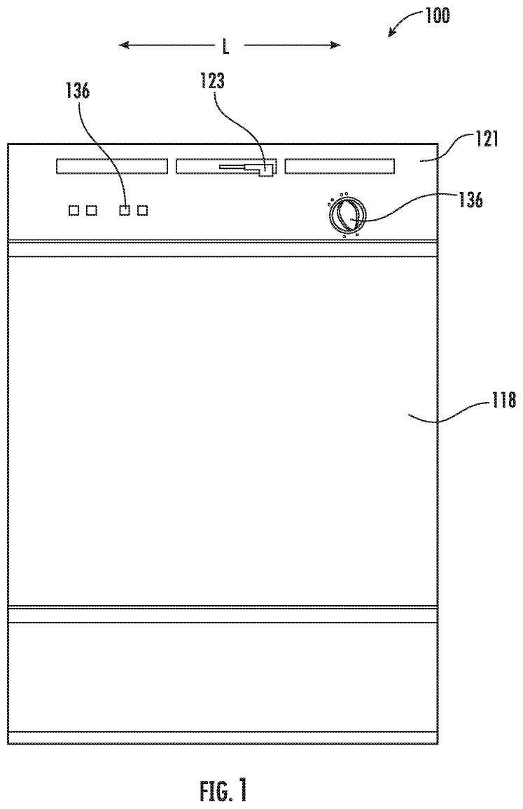

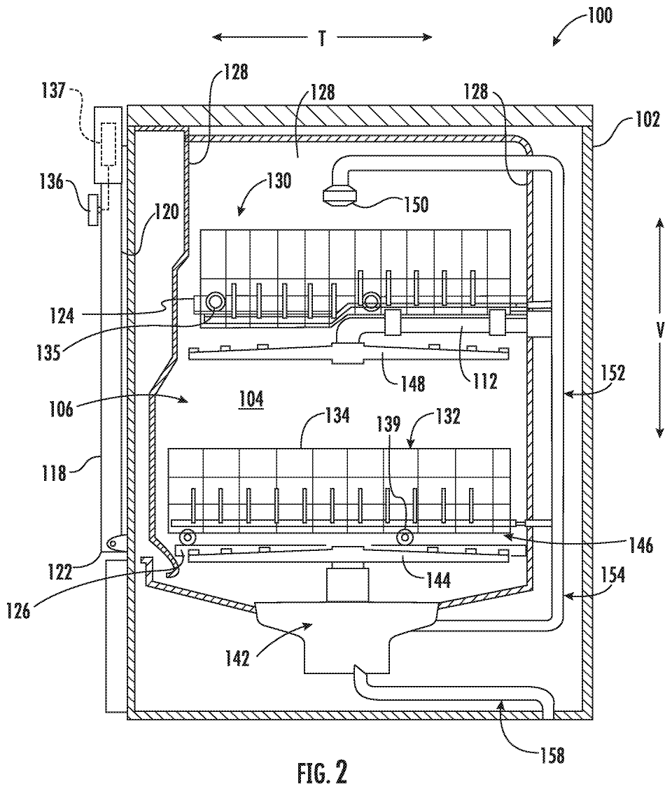

FIGS. 1 and 2 depict an exemplary domestic dishwasher 100 that may be configured in accordance with aspects of the present disclosure. As shown, the dishwasher 100 includes a cabinet 102 having a tub 104 therein that defines a wash chamber 106. Tub 104 includes a plurality of sidewalls 128 that define the wash chamber 106. The tub 104 further includes a front opening (not shown) and a door 118 hinged at its bottom 122 for movement between a normally closed vertical position (shown in FIGS. 1 and 2), wherein the wash chamber 106 is sealed shut for a washing operation or wash cycle, and a horizontal open position for loading and unloading of articles from the dishwasher. Latch 123 is used to lock and unlock door 118 for access to chamber 106. Door 118 includes an inner wall 120. The inner wall 120 further defines the wash chamber 106 when the door 118 is in the closed position.

Upper and lower guide rails 124, 126 are mounted on tub side walls 128 and accommodate roller-equipped rack assemblies 130 and 132. Each of the rack assemblies 130, 132 is fabricated into lattice structures including a plurality of elongated members 134 (for clarity of illustration, not all elongated members making up assemblies 130 and 132 are shown in FIG. 2). Each rack assembly 130, 132 is arranged in the wash chamber 106, such that the rack assembly 130, 132 is capable of movement between an extended loading position (not shown) in which the rack is substantially positioned outside the wash chamber 106, and a retracted position (shown in FIGS. 1 and 2) in which the rack is located inside the wash chamber 106. This is, for example, facilitated by rollers 135 and 139, for example, mounted onto rack assemblies 130 and 132, respectively. A silverware basket (not shown) may be removably attached to rack assembly 132 for placement of silverware, utensils, and the like, that are otherwise too small to be accommodated by the rack assemblies 130, 132.

The dishwasher 100 further includes a lower spray-arm assembly 144 that is rotatably mounted within a lower region 146 of the wash chamber 106 and above a sump 142 so as to rotate in relatively close proximity to rack assembly 132. In some embodiments, a mid-level spray-arm assembly 148 is located in an upper region of the wash chamber 106 and may be located in close proximity to upper rack 130. Additionally or alternatively, an upper spray assembly 150 may be located above the upper rack 130.

Each spray-arm assembly 144, 148 includes an arrangement of discharge ports or orifices for directing fluid onto dishes or other articles located in rack assemblies 130 and 132. The arrangement of the discharge ports in spray-arm assemblies 144, 148 provides a rotational force by virtue of washing fluid flowing through the discharge ports. The resultant rotation of the spray-arm assemblies 144, 148 and the operation of spray assembly 150 provides coverage of dishes and other dishwasher contents with a washing spray. Other configurations of spray assemblies may be used as well.

The lower and mid-level spray-arm assemblies 144, 148 and the upper spray assembly 150 may be provided as part of a fluid circulation assembly 152 for circulating water and dishwasher fluid in the tub 104. In some embodiments, fluid circulation assembly 152 includes a circulation conduit 154 that supplies the fluid to the lower and mid-level spray-arm assemblies 144, 148 or the upper spray assembly 150. The conduit 154 may, for example, be in fluid communication with the sump 142 such that fluid can flow from the sump 142 into the conduit 154 as required.

As noted above, dishwasher assembly 100 further includes sump 142, which may be provided in lower region 146 below, for example, lower spray-arm assembly 144. Sump 142 generally collects fluid from the wash chamber 106 for circulation within the tub 104, such as back into the wash chamber 106 through fluid circulation assembly 152, as well as drainage from the tub 104 and dishwasher appliance 100 in general. Drainage may occur, for example, through a drain conduit 158 that is provided for draining fluid from the sump 142. The conduit 158 may, for example, be in fluid communication with the sump 142 such that fluid can flow from the sump 142 into the conduit 158 as required. Drain conduit 158 may flow the fluid from the sump 142 to, for example, external plumbing or another suitable drainage location.

In optional embodiments, a flood float cover 160 is disposed within the wash chamber 106, and may generally cover a flood float (not shown). The flood float prevents excess fluid from flowing into the dishwasher appliance, as is generally understood. The flood float and cover 160 may generally be disposed in lower region 146.

As shown, dishwasher 100 is further equipped with a controller 137 to regulate operation of the dishwasher 100. The controller may include one or more memory devices and one or more microprocessors, such as general or special purpose microprocessors operable to execute programming instructions or micro-control code associated with a wash cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher 100. In the illustrated embodiment, the controller 137 may be located within a control panel area 121 of door 118 as shown in FIGS. 1 and 2. In such an embodiment, input/output (“I/O”) signals may be routed between the control system and various operational components of dishwasher 100 along wiring harnesses that may be routed through the bottom 122 of door 118. Typically, the controller 137 includes a user interface panel or controls 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

It should be appreciated that the invention is not limited to any particular style, model, or configuration of dishwasher. The exemplary embodiments depicted in FIGS. 1 and 2 are for illustrative purposes only. For example, different locations may be provided for user interface 136, different configurations may be provided for racks 130, 132, and other differences may be applied as well.

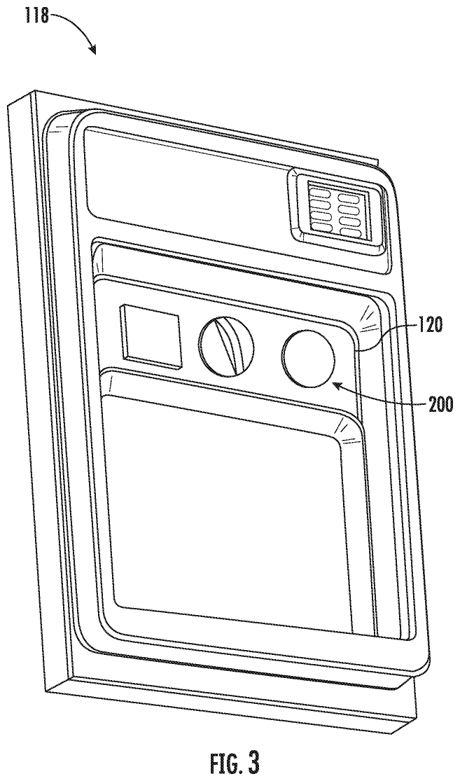

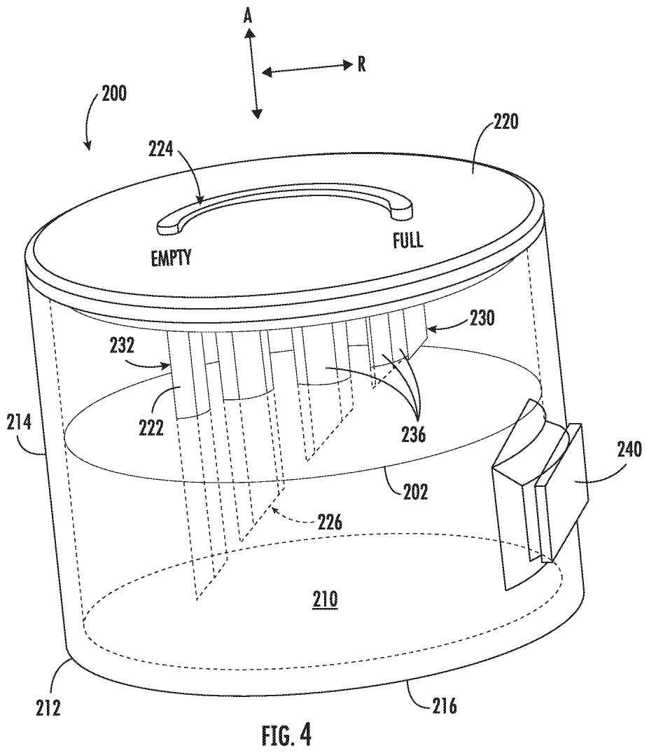

Turning now to FIG. 3, a perspective view is provided for a door 118, such as that for dishwasher 100 (FIGS. 1 and 2). In some embodiments, a dispensing assembly 200 is provided at or on an inner portion of door 118 to receive and dispense the wash fluid (e.g., liquid cleaning agent) to the wash chamber 106. In particular, dispensing assembly 200 may be attached to the inner wall 120 of the door 118. A hole or aperture defined through the inner wall 120 may receive or otherwise define an opening for fluid communication with a storage volume or reservoir 210 (FIG. 4) of the dispensing assembly 200, as will be described below. Thus, dispensing assembly 200 may be fixed to the door 118 and thereby move with the door 118 (e.g., as it is moved between the open and closed positions).

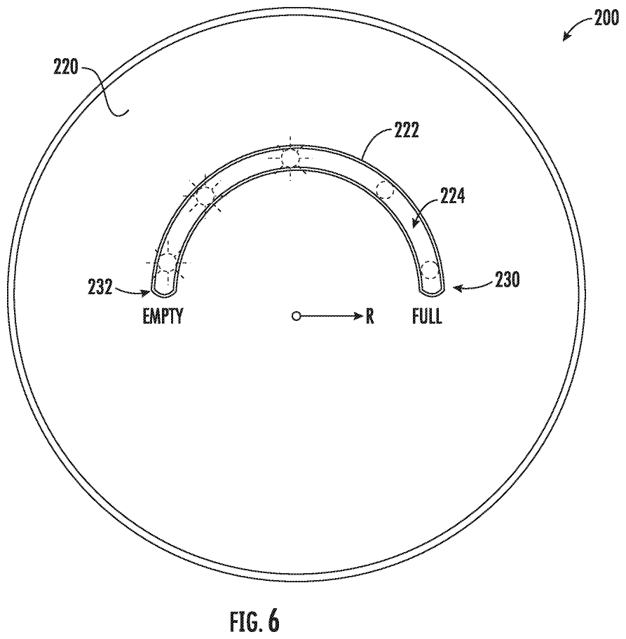

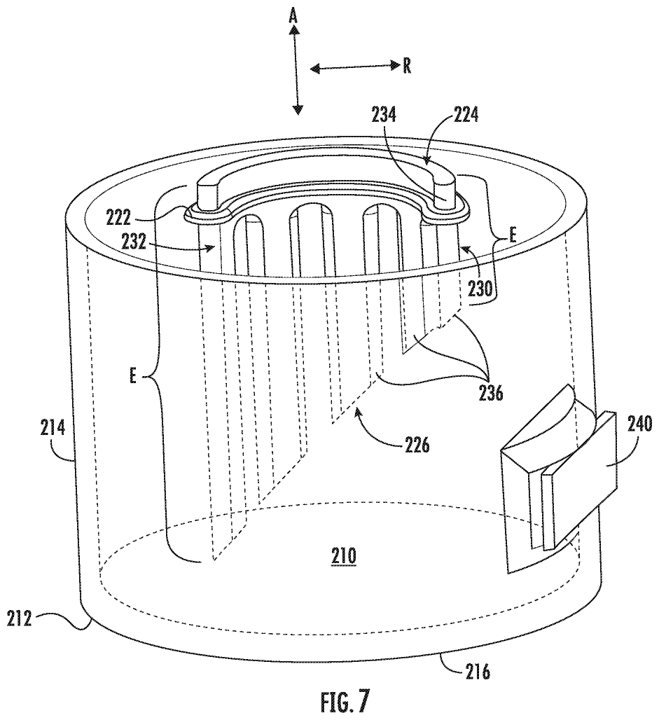

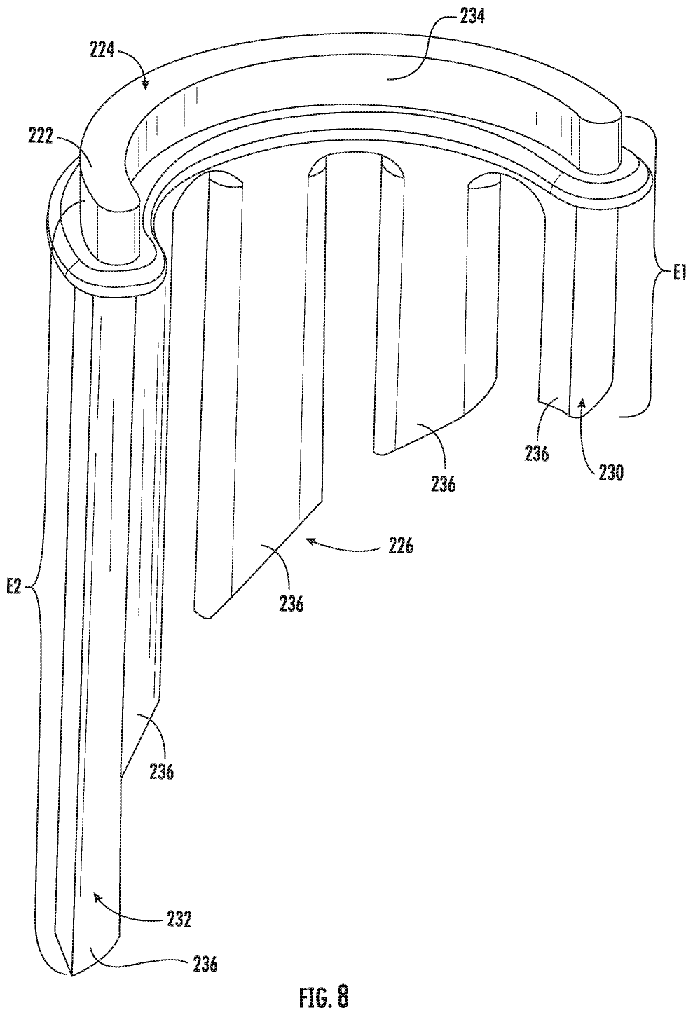

Turning now generally to FIGS. 4 through 8 and 10, various views are provided of a dispensing assembly 200 according to exemplary embodiments of the present disclosure. As shown, dispensing assembly 200 includes an internal wall 212 defining a storage volume 210 to receive or hold a wash fluid (e.g., liquid cleaning agent 202) therein. Internal wall 212 includes one or more sidewalls 214 that generally extend along an axial direction A. In particular, sidewalls 214 may extend in the axial direction A between a front and a back end (e.g., parallel to the axial direction A or at an otherwise non-perpendicular angle relative thereto). A base wall 216 of internal wall 212 may extend across the axial direction A (e.g., along the radial direction R perpendicular to the axial direction A) from the one or more sidewalls 214. In turn, the base wall 216 may connect the one or more sidewalls 214 and partially enclose the storage volume 210. The front opening 218 may be defined by the one or more sidewalls 214 from the base wall 216. Optionally, a separate dispensing outlet (not shown) may be provided through sidewalls 214 or base wall 216 for the selective release of wash fluid or cleaning agent to the wash tub 106. As shown, internal wall 212 may be formed as an open cylinder in exemplary embodiments. However any other suitable shape for receiving and containing liquids, such as a cleaning agent, may be provided in alternative embodiments.

As noted above, the dispensing assembly 200 may be mounted to the door 118 (FIG. 3) to move or rotate therewith. In some embodiments, when door 118 is in the closed position, the axial direction A may be parallel to the transverse direction T and perpendicular to vertical direction V (FIG. 2). By contrast, when the door 118 is in the open position, the axial direction A may be parallel to the vertical direction V and perpendicular to the transverse direction T.

In certain embodiments, a front cover 220 is provided to selectively cover or close storage volume 210. For instance, the front cover 220 may be removably placed over the front opening 218, enclosing storage volume 210 and restricting access thereto. Thus, when the door 118 (FIG. 2) is in the closed position, the front cover 220 is positioned between storage volume 210 and wash chamber 106. Generally, front cover 220 may be provided as any movable (e.g., removable) and nonpermeable body to selectively cover front opening 218. In some embodiments, front cover 220 is formed as a plastic or rubber member selectively held to internal wall 212 by a friction fit (e.g., between the sidewalls 214 and a perimeter of front cover 220). Additionally or alternatively, one or more mechanical latches (not shown) may be provided to selectively hold front cover 220 over front opening 218.

When desired, such as when adding wash fluid to storage volume 210, front cover 220 may be moved apart from front opening 218 or otherwise adjusted such that access to storage volume 210 is permitted. Moreover, although the illustrated as a friction fit member in the figures, any suitable additional or alternative features may be provided to permit front cover 220 to selectively move relative to storage volume 210, such as a hinge or threaded collar attaching front cover 220 to internal wall 212 or door 118.

A light guide 222 is provided to extend within at least a portion of storage volume 210. In particular, light guide 222 may extend along (e.g., parallel to) the axial direction A from a forward display surface 224 to a rearward contact surface 226. When assembled, the rearward contact surface 226 is generally positioned proximal to base wall 216 and forward display surface 224 is positioned distal to base wall 216 (e.g., proximal to front opening 218). Thus, rearward contact surface 226 is positioned in front of storage volume 210 (e.g., when the front cover 220 is positioned on the internal wall 212).

As shown, light guide 222 further extends in the radial direction R between a first radial end 230 and a second radial end 232. In some embodiments, light guide 222 provides a generally curved or arcuate body that extends in a non-linear shape between first radial end 230 and second radial end 232. However, in alternative embodiments, light guide 222 provided as any other suitable shape. For instance, light guide 222 may provide a linear or straight body that extends in a non-curved linear shape between first radial end 230 and second radial end 232.

Generally, it is understood that light guide 222 may be formed from any suitable transparent or translucent material to direct light therethrough. For instance, light guide 222 may be formed, at least in part, by suitable polymer (e.g., acrylic, polycarbonate, etc.) to direct light from the rearward contact surface 226 to the forward display surface 224. Additionally or alternatively, one or more surfaces of the light guide 222 may be formed as rough or textured surfaces. In particular, the rearward contact surface 226 may be formed as a textured surface to disperse light entering the light guide 222. For instance, the textured surface may define a surface roughness value that is higher than another exterior surface of the light guide 222. Optionally, the surface roughness of the textured surface may be a roughness value (Ra) between 1 micrometers and 0.8 micrometers.

Generally, forward display surface 224 is visible when front cover 220 is positioned on sidewall 214, or otherwise covers front opening 218. Optionally, forward display surface 224 may be formed on a solid display body 234. As shown, solid display body 234 may be provided as a continuous or uninterrupted member between first radial end 230 and second radial end 232. Forward display surface 224 may thus provide a continuous surface between first radial end 230 and second radial end 232.

In certain embodiments, light guide 222 is attached to front cover 220. As an example, forward display surface 224 may be embedded within front cover 220. When cover is positioned over front opening 218, forward display surface 224 may thus be visible while rearward contact surface 226 is obscured behind front cover 220 within storage volume 210.

In some embodiments, light guide 222 defines a gradient axial length E between first radial end 230 and second radial end 232. In particular, the gradient axial length E may increase from first radial end 230 to second radial end 232. Thus, a relatively short axial length E1 (e.g., from forward display surface 224 to rearward contact surface 226) may be defined at first radial end 230 while a relatively long axial length E2 (e.g., from forward display surface 224 to rearward contact surface 226) is defined at second radial end 232. In some such embodiments, forward display surface 224 may be generally parallel to the radial direction R. Thus, the gradient or slope of axial length E may be formed along rearward contact surface 226. The gradient or slope of axial length E may be formed as a linear slope (e.g., at a constant predetermined angle relative to the axial direction A between first radial end 230 and second radial end 232) or, alternatively, as a nonlinear curve or index. As would be understood, the nonlinear curve includes multiple discrete angles (e.g., relative to the axial direction A). The index gradient is understood to include discrete stages defining parallel portions of rearward surface 226 (e.g., parallel to the radial direction R) such that a predetermined axial distance is defined between each adjacent stage (e.g., such that a step function or tiered arrangement is defined by the adjacent stages of axial length E).

In exemplary embodiments, such as those illustrated in FIGS. 4 through 8, light guide 222 includes a plurality of discrete light pipes 236. For instance, each light pipe 236 may extend along the axial direction A from a discrete location along display body 234. Adjacent light pipes 236 may be spaced apart from each other (e.g., along the radial direction R or another direction otherwise perpendicular to the axial direction A). Thus, an axial channel 238 may be defined between each adjacent pair of light pipes 236. Optionally, each axial channel 238 may define an identical channel width C (e.g., perpendicular to the axial direction A). Additionally or alternatively, each light pipe 236 may define an identical pipe width P (e.g., perpendicular to the axial direction A). As described above, light guide 222 may define an axial length E. In certain embodiments, each light pipe 236 defines a unique axial length. For instance, following a path from the first radial end 230 to the second radial end 232, each subsequent light pipe 236 may define an axial length (e.g., length E1 or E2) that is longer than the prior adjacent light pipe 236 along the path.

In some embodiments, one or more surfaces of the light guide 222 are slanted or angled relative to the axial direction A. For instance, one or more portions of the rearward contact surface 226 may define a predetermined nonorthogonal angle θ relative to the axial direction A. For instance, the predetermined nonorthogonal angle θ may be an angle between 50° and 75° relative to the axial direction A. In some such embodiments, the rearward contact surface 226 is at least partially directed towards or faces the sidewall 214. In exemplary embodiments, one or more of the light pipes 236 include a portion of the rearward contact surface 226 defined along the predetermined nonorthogonal angle θ. Optionally, each light pipe 236 may include a portion of the rearward contact surface 226 defined along the predetermined nonorthogonal angle θ. Additionally or alternatively, the predetermined nonorthogonal angle θ may be identical for each light pipe 236.

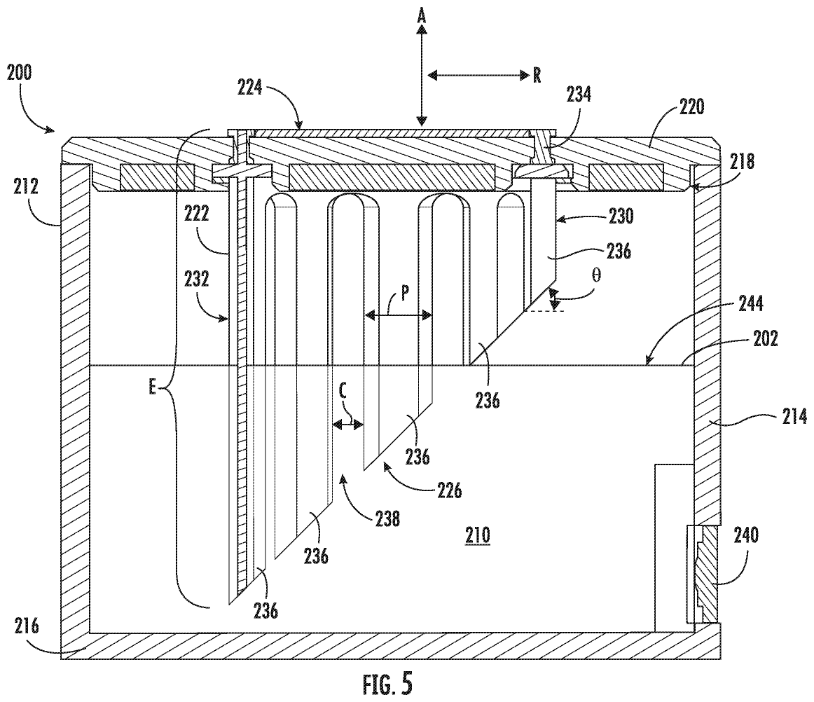

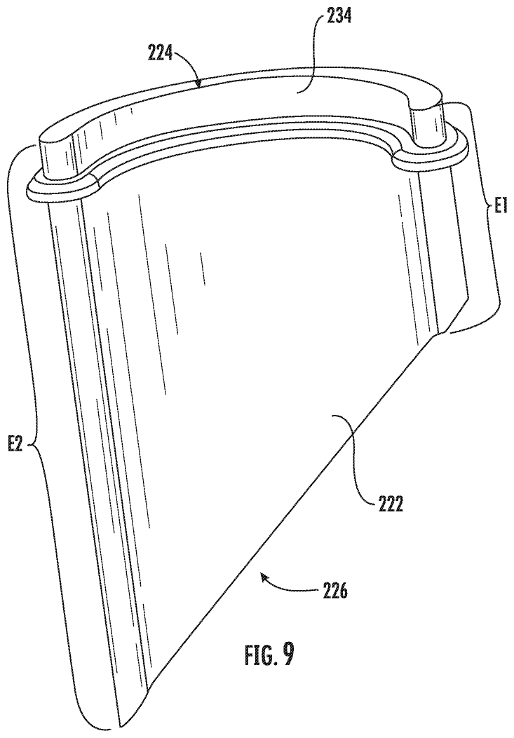

Turning briefly to FIG. 9, some embodiments include a light guide 222 having a rearward contact surface 226 that extends continuously from the first radial end 230 to the second radial end 232. The rearward contact surface 226 of such embodiments may define a gradient of axial length E along, for instance, the predetermined nonorthogonal angle θ (see FIG. 5). In other words, the rearward contact surface 226 may follow the predetermined nonorthogonal angle θ from the first radial end 230 to the second radial end 232. Moreover, the axial length E1 of first radial end 230 may be shorter than the axial length E2 of second radial end 232.

Returning to FIGS. 4 through 8 and 10, a light source 240 is provided to illuminate at least a portion of storage volume 210 or light guide 222. Generally, light source 240 may include any suitable device for projecting visible light emissions (e.g., as indicated at arrows 242) to storage volume 210. For instance, light source 240 may include one or more light emitting diodes, incandescent bulbs, fluorescent bulbs, or laser protection systems. Optionally, light source 240 may be operably coupled to controller 137 (e.g., to receive signals therefrom). Controller 137 may be configured to selectively illuminate light source 240 based on one or more predetermined conditions (e.g., detection of door 118 in an open or otherwise not closed position, activation of a light switch/input, etc.). In some embodiments, light source 240 is configured to illuminate or project emissions 242 at a predetermined color (i.e., wavelength along the visible color spectrum). Optionally, the predetermined color may be a blue or green color, which may be easily viewed by the human eye.

As shown, light source 240 is positioned to direct light emissions 242 through internal wall 212. In particular, light source 240 may be directed toward the rearward contact surface 226 of light guide 222 within storage volume 210. In exemplary embodiments, light source 240 is positioned on (e.g., mounted at or adjacent to) internal wall 212. As an example, light source 240 may be positioned on sidewall 214. In some such embodiments, light source 240 is generally directed in the radial direction R. As an additional or alternative example, light source 240 may be positioned on base wall 216. In some such embodiments, light source 240 is generally directed in the axial direction A. At least a portion of the internal wall 212 between light source 240 and storage volume 210 may provide a transparent lens through which light emissions 242 may pass.

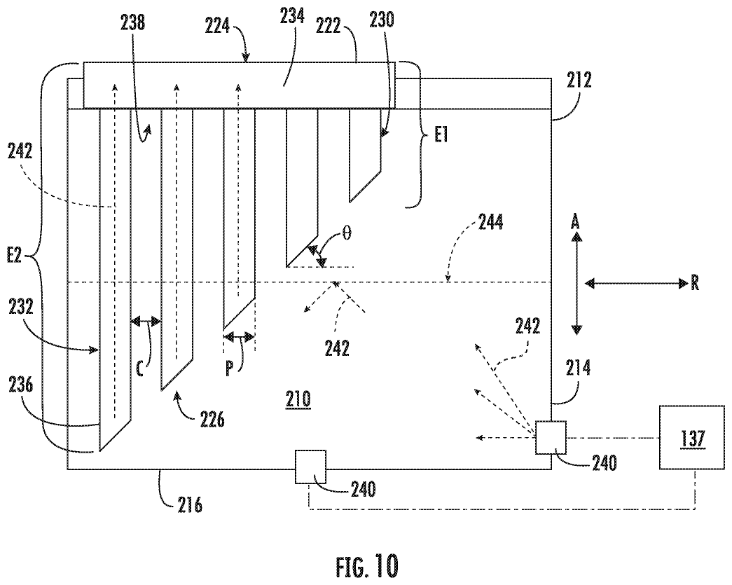

Turning especially to FIG. 10, when assembled, rearward contact surface 226 may be generally directed toward light source 240 to receive emissions 242 therefrom. Rearward contact surface 226 is positioned between light source 240 in front cover 220 relative to the axial direction A. In other words, when the axial direction A is parallel to the vertical direction V (FIG. 2), such as when door 118 is in the open position, light source 240 may be positioned below or lower than rearward contact surface 226.

In certain embodiments, light source 240 is positioned closer to the first radial end 230 of light guide 222 than it is to the second radial end 232 of light guide 222 (e.g., along the radial direction R). The first radial end 230 may thus be positioned proximal to the light source 240 along the radial direction R, while the second radial end 232 is positioned distal to the light source 240 along the radial direction R. In some such embodiments, such as those illustrated at FIG. 10, the shortest portion of light guide 222 (e.g., axial length E1) may be the portion of light guide 222 positioned closest to light source 240 along the radial direction R. The longest portion of light guide 222 (e.g., axial length E2) may be the portion of light guide 222 positioned furthest from light source 240 along the radial direction R. In additional or alternative embodiments, the gradient of the rearward contact surface 226 may descend in relation to the radial distance from the light source 240. In other words, the axial length of light guide 222 may generally increase from length E1 to E2 with radial distance from the light source 240.

As shown, the angled portions of rearward contact surface 226 may be open to or otherwise face light source 240. Thus, light emissions 242 projected from light source 240 may be transmitted through a liquid cleaning agent and received at a portion of the rearward contact surface 226 that is submerged below an upper surface 244 of the liquid cleaning agent within storage volume 210. At least a portion of the light emissions 242 from light source 240 may be reflected by the upper surface 244 of liquid cleaning agent. Portions of the rearward contact surface 226 that are positioned above the upper surface 244 will thus receive less transmitted light than portions of the rearward contact surface 226 below or behind the upper surface 244 relative to the axial direction A. Light emissions 242 received at the rearward contact surface 226 may be transmitted along the axial direction A to forward display surface 224, advantageously providing a clear visual indication of the volume of liquid cleaning agent within storage volume 210 (e.g., as would be understood by the axial distance between base wall 216 and upper surface 244). Furthermore, the gradient axial length of light guide 222 (e.g., increasing away from light source 240) may advantageously permit light emissions 242 from a single light source.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance comprising:
a tub defining a wash chamber for receipt of articles for washing, the tub comprising a plurality of sidewalls;
a door movable between a closed position and an open position, the door comprising an inner wall further defining the wash chamber when the door is in the closed position; and
a cleaning agent dispensing assembly mounted to the door, the cleaning agent dispensing assembly comprising
an internal wall defining a storage volume for the receipt of a wash fluid therein,
a front cover selectively covering the storage volume to restrict access thereto, the front cover being positioned between the storage volume and the wash chamber when the door is in the closed position,
a light guide extending along an axial direction from a forward display surface in front of the storage volume to a rearward contact surface within the storage volume, and
a light source directed through the internal wall toward the rearward contact surface within the storage volume.

2. The dishwasher appliance of claim 1, wherein the rearward contact surface is defined at a non-orthogonal angle relative to the axial direction.

3. The dishwasher appliance of claim 1, wherein the rearward contact surface is defined as a textured translucent surface.

4. The dishwasher appliance of claim 1, wherein the internal wall comprises a sidewall extending along the axial direction and a base wall extending across the axial direction from the sidewall, and wherein the light source is positioned on the sidewall.

5. The dishwasher appliance of claim 1, wherein the internal wall comprises a sidewall extending along the axial direction and a base wall extending across the axial direction from the sidewall, and wherein the light source is positioned on the base wall.

6. The dishwasher appliance of claim 1, wherein the rearward contact surface is positioned between the light source and front cover relative to the axial direction.

7. The dishwasher appliance of claim 1, wherein the light guide comprises a plurality of discrete light pipes, and wherein each light pipe of the plurality of discrete light pipes is defines a unique axial length.

8. The dishwasher appliance of claim 1, wherein the light guide defines a gradient axial length between a first radial end and a second radial end, wherein the gradient axial length increases from the first radial end to the second radial end.

9. The dishwasher appliance of claim 8, wherein the first radial end is positioned proximal to the light source along a radial direction, and wherein the second radial end is positioned distal to the light source along the radial direction.

10. The dishwasher appliance of claim 8, wherein the rearward contact surface extends continuously from the first radial end to the second radial end.

11. A cleaning agent dispensing assembly for a dishwashing appliance, the cleaning agent dispensing assembly comprising:
an internal wall defining a storage volume for the receipt of a wash fluid therein;
a front cover selectively covering the storage volume to restrict access thereto;
a light guide extending along an axial direction from a forward display surface at the front cover to a rearward contact surface within the storage volume; and
a light source directed through the internal wall toward the rearward contact surface within the storage volume.

12. The cleaning agent dispensing assembly of claim 11, wherein the rearward contact surface is defined at a non-orthogonal angle relative to the axial direction.

13. The cleaning agent dispensing assembly of claim 11, wherein the rearward contact surface is defined as a textured translucent surface.

14. The cleaning agent dispensing assembly of claim 11, wherein the internal wall comprises a sidewall extending along the axial direction and a base wall extending across the axial direction from the sidewall, and wherein the light source is positioned on the sidewall.

15. The cleaning agent dispensing assembly of claim 11, wherein the internal wall comprises a sidewall extending along the axial direction and a base wall extending across the axial direction from the sidewall, and wherein the light source is positioned on the base wall.

16. The cleaning agent dispensing assembly of claim 11, wherein the rearward contact surface is positioned between the light source and front cover relative to the axial direction.

17. The cleaning agent dispensing assembly of claim 11, wherein the light guide comprises a plurality of discrete light pipes, and wherein each light pipe of the plurality of discrete light pipes is defines a unique axial length.

18. The cleaning agent dispensing assembly of claim 11, wherein the light guide defines a gradient axial length between a first radial end and a second radial end, wherein the gradient axial length increases from the first radial end to the second radial end.

19. The cleaning agent dispensing assembly of claim 18, wherein the first radial end is positioned proximal to the light source along a radial direction, and wherein the second radial end is positioned distal to the light source along the radial direction.

20. The cleaning agent dispensing assembly of claim 18, wherein the rearward contact surface extends continuously from the first radial end to the second radial end.
